(19) United States
(12) Patent Application Publication
(10) Pub. No.: US 2023/0169420 A1
(43) Pub. Date: Jun. 1, 2023

(54) PREDICTING A DRIVER IDENTITY FOR UNASSIGNED DRIVING TIME

(71) Applicant: MOTIVE TECHNOLOGIES, INC., San Francisco, CA (US)

(72) Inventors: Raghu Dhara, Fremont, CA (US); Dimple, Bengaluru (IN); Chris CHEN, Oakland, CA (US)

(21) Appl. No.: 17/537,928

(22) Filed: Nov. 30, 2021

(51) Int. Cl. G06Q 10/06; G06N 5/02; G06N 20/00

(52) U.S. Cl. CPC G06Q 10/06311; G06N 5/02; G06N 20/00

(57) ABSTRACT

The disclosed embodiments provide techniques for assigning drivers to unassigned trips using a predictive model. In one embodiment, a method is disclosed comprising loading heuristic data associated with a trip performed by a vehicle, the heuristic data comprising at least one driver identifier; identifying a plurality of driver identifiers near to the vehicle during the trip, the plurality of driver identifiers based on mobile device data and in-vehicle monitoring data; generating a set of binary comparisons based on the heuristic data; and generating a set of vectors based on the plurality of driver identifiers and the set of binary comparisons.

### BACKGROUND

The disclosed embodiments are directed toward the automatic assignment of drivers to unassigned vehicle trips.

In many countries, commercial vehicle operators are required to account for all driver and vehicle movement. Generally, a vehicle operator can account for driver and vehicle movement by assigning drivers to all detected movements of a vehicle. Government entities may fine or suspend vehicle operators that fail to account for such time. To avoid such penalties, most operators utilize electronic logging device (ELD) solutions that monitor the movement of vehicles. However, such solutions only monitor vehicle movements and cannot automatically associate specific drivers to vehicle movements if the driver does not use an identifying intermediary (e.g., a mobile device paired to the ELD). As such, these solutions require the manual identification of drivers. Some newer solutions utilize facial recognition on images captured by inward-facing cameras (i.e., cameras recording a driver). However, the accuracy of these solutions is not high enough to use reliably standalone and requires significant training data to improve, which may not be feasible for a large fleet or a fleet with significant turnover. As such, current solutions fail to accurately and efficiently assign drivers to unassigned vehicle movements.

### BRIEF SUMMARY

The disclosed embodiments solve these and other problems by automatically assigning a driver identifier to an unassigned trip using a predictive model. The example embodiments leverage mobile device pings and in-vehicle monitoring device pings to generate a candidate listing of potential drivers. The example embodiments then utilize heuristic data to generate a set of binary comparisons and generate a feature vector for each candidate user that describes the potential matching driver. These vectors are then used to train a predictive model (e.g., binary classifier), and the predictive model can then be used to automatically identify a driver for an unassigned trip.

In an embodiment, a method is disclosed that includes loading heuristic data associated with a trip performed by a vehicle, the heuristic data comprising at least one driver identifier, identifying a plurality of driver identifiers near to the vehicle during the trip, the plurality of driver identifiers based on mobile device data and in-vehicle monitoring data, generating a set of binary comparisons based on the heuristic data, and generating a set of vectors based on the plurality of driver identifiers and the set of binary comparisons.

In an embodiment, the method can include classifying the set of vectors to obtain a set of predictions, selecting a prediction from the set of predictions, and assigning a driver identifier associated with the prediction to the trip.

In an embodiment, classifying the set of vectors can include the use of a predictive model to generate a binary classification for each vector in the set of vectors.

In an embodiment, the method can include assigning a label to each vector in the set of vectors to generate a set of labeled vectors and training a predictive model using the labeled vectors, the predictive model generating a binary classification for each vector in the set of vectors.

In an embodiment, the heuristic data comprises driver identifiers associated with one or more of a previous trip, a next trip, and an inspection report. In an embodiment, generating a set of binary comparisons can include comparing a candidate driver identifier to the driver identifiers in the heuristic data and to a matching driver identifier in the plurality of driver identifiers.

In an embodiment, identifying a plurality of driver identifiers near to the vehicle during the trip can include analyzing position and time data associated with a plurality of mobile device pings and a plurality of in-vehicle monitoring device pings and generating a feature vector based on the analysis.

In various further embodiments, the disclosure provides devices, systems, and non-transitory computer-readable storage media for implementing or executing the aforementioned method embodiments.

### BRIEF DESCRIPTION OF THE DRAWINGS

FIG. 1 is a diagram illustrating a timeline of data recorded during the operation of a vehicle according to some of the example embodiments.

FIG. 2 is a block diagram illustrating a system for predicting a driver for an unassigned trip according to some of the example embodiments.

FIG. 3 is a flow diagram of a method for calculating location scores for drivers associated with an unassigned trip according to some of the example embodiments.

FIG. 4 is a flow diagram of a method training a driver model according to some of the example embodiments.

FIG. 5 is a flow diagram of a method for assigning a driver to unassigned driving time according to some of the example embodiments.

FIG. 6 is a block diagram of a computing device according to some embodiments of the disclosure.

### DETAILED DESCRIPTION

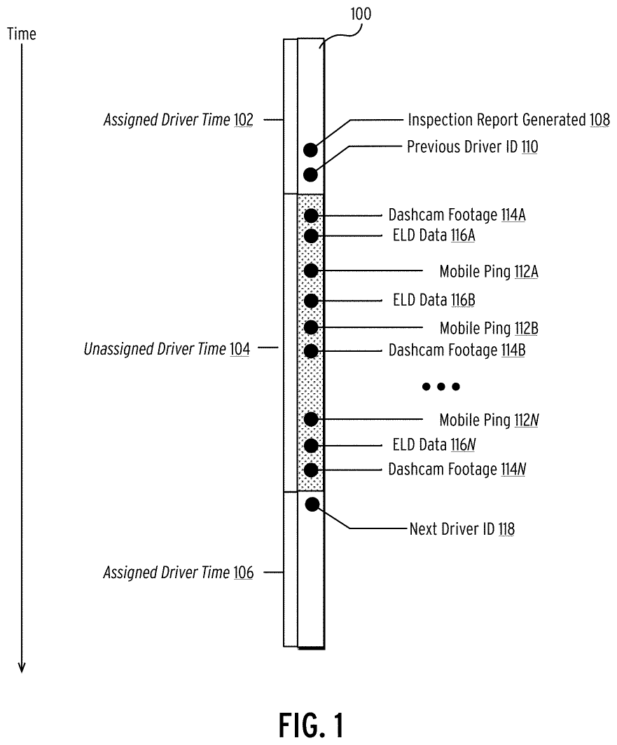

FIG. 1 is a diagram illustrating a timeline of data recorded during the operation of a vehicle according to some of the example embodiments.

The illustrated timeline 100 represents a segment of unassigned driver time 104 (also referred to as an unassigned trip) for a given vehicle. As illustrated, timeline 100 can additionally include assigned driver time 102 and assigned driver time 106 occurring before and after unassigned driver time 104, respectively (assigned driver time is also referred to as an assigned trip). As used herein, an “unassigned” trip refers to a period of time in which a fleet operator or other vehicle owner cannot match a trip to a known driver (e.g., via a unique identifier for the driver). Such mismatches may occur due to technical problems with vehicular systems (e.g., the inability of a driver to authenticate to an in-vehicle monitoring device such as an ELD) or nefarious actions (e.g., tampering with such devices).

In the various embodiments, multiple electronic devices can generate data streams relevant to a vehicle. As one example, a vehicle can include an ELD that periodically reports data to a central platform. This data can include vehicular data (e.g., engine status, speed, etc.) as well as geographic data (e.g., latitude and longitude). Similarly, a driver of the vehicle can own and/or operate a mobile device equipped with an application that reports data to the central platform. For example, the mobile device can include an application that is “paired” with the ELD and allows for bidirectional communications. In some embodiments, the ELD can also act as a Wireless Fidelity (Wi-Fi) hotspot, enabling broadband access to the mobile device. Generally, a mobile device and an in-vehicle monitoring device can operate independently. Thus, in some embodiments, the central platform can receive data from each but may not be able to combine the separate streams into a single stream.

In the illustrated timeline 100, various “pings” are illustrated as darkened circles within the illustrated timeline 100. As used herein, a “ping” refers to data received from a known electronic device (e.g., mobile device, ELD, dashcam, etc.). As discussed herein, in some embodiments, these pings are not synchronized and thus cannot easily be combined. By contrast, some pings can be readily associated with a driver or vehicle.

In the illustrated embodiment, the pings include an inspection report ping 108, a previous driver identifier ping 110, and a next driver identifier ping 118. In an embodiment, an inspection report ping 108 can be received when a driver completes an inspection form prior to starting a trip or after completing a trip. In the illustrated embodiment, the inspection report ping 108 corresponds to a post-trip inspection ping. The previous driver identifier ping 110 comprises a transmission of a driver identifier associated with the assigned driver time 102, while the next driver identifier ping 118 comprises the driver identifier associated with the assigned driver time 106. In some embodiments, the previous driver identifier ping 110 and next driver identifier ping 118 can be synthesized from other (e.g., authenticated) transmissions and may not comprise dedicated pings.

In the illustrated embodiment, during the unassigned driver time 104 multiple pings are received, including dashcam footage ping 114A, ELD data ping 116A, mobile ping 112A, dashcam footage ping 114B, ELD data ping 116B, mobile ping 112B, dashcam footage ping 114N, ELD data ping 116N, mobile ping 112N. No limit is placed on the number of pings received during unassigned driver time 104. In the illustrated embodiment, a dashcam footage ping can comprise an image captured by a dashcam mounted in a vehicle. In some embodiments, the image can be associated with a vehicle identifier (but not a specific driver identifier). In the illustrated embodiment, an ELD data ping can comprise data transmitted by an in-vehicle monitoring device. The ELD data ping can also be associated with a specific vehicle but not a specific driver. In the illustrated embodiment, a mobile ping can comprise data received from a mobile application installed on a mobile device operated by a driver. Mobile pings are associated with drivers but may not be associated with vehicles. Although illustrated timeline 100 illustrates a timeline for a single vehicle, many such timelines may exist for each vehicle. Further, the various pings can be received globally, and no knowledge of the specific vehicle represented by the illustrated timeline 100 is presumed.

As illustrated in illustrated timeline 100, during unassigned driver time 104, various data streams are received; however, the streams cannot automatically be linked to provide a combination of vehicle identifier and driver identifier. The problem can further be compounded due to the fact that many drivers may be present during the unassigned driving time due to, for example, the pooling of vehicles in centralized locations (e.g., rest stops, loading zones, etc.) as well as the general congestion of vehicles on roadways. As such, the unassigned driver time 104 is flagged as unassigned since a driver cannot be easily identified based on the raw data. As will be discussed next, a central platform leverages these data streams, a location scoring routine, and a predictive model to determine the most likely driver for a given unassigned trip.

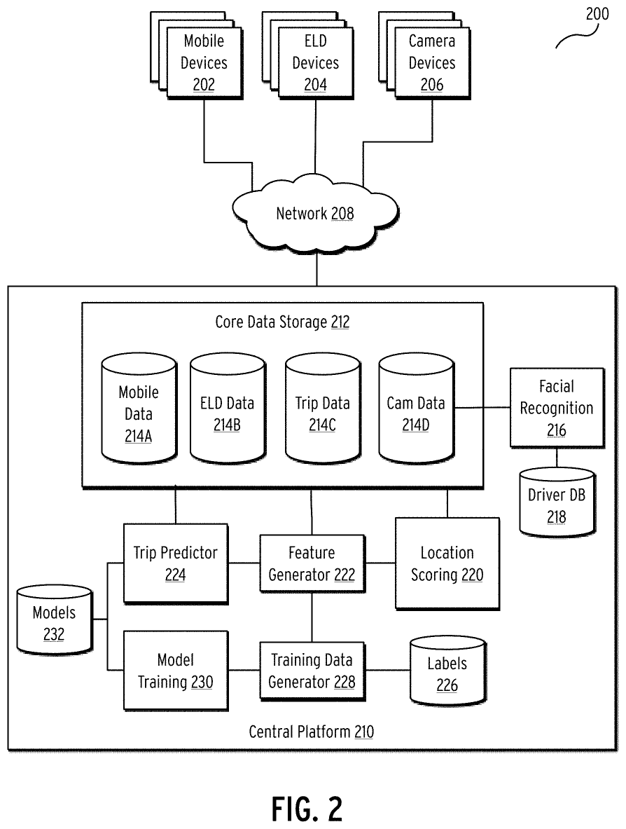

FIG. 2 is a block diagram illustrating a system 200 for predicting a driver for an unassigned trip according to some of the example embodiments.

In system 200, mobile devices 202, in-vehicle monitoring devices 204, and camera devices 206 are communicatively coupled to a central platform 210 via a network 208 (e.g., a wide-area network such as the Internet).

The mobile devices 202 can include devices such as mobile phones, tablets, and other portable electronic devices. The mobile devices 202 can include software that periodically generates data for transmission to central platform 210 via network 208. For example, the mobile devices 202 can include a mobile application that allows drivers to authenticate (and be assigned a driver identifier) and report data such as inspection data as well as perform other operations. The mobile application can further generate “ping” data which can comprise a heartbeat signal that includes the current geographic position of the mobile device running the mobile application. In some embodiments, all data transmissions from mobile devices 202 to central platform 210 can include a geographic position.

The in-vehicle monitoring devices 204 can include electronic devices installed within vehicles. For example, in-vehicle monitoring devices 204 can comprise ELDs or similar devices physically installed within a vehicle. In some embodiments, the in-vehicle monitoring devices 204 can be communicatively coupled to the control system of a vehicle (e.g., via an onboard diagnostic port or similar port). The in-vehicle monitoring devices 204 can receive telematics data regarding the vehicle (e.g., speed, brake status, etc.). The in-vehicle monitoring devices 204 can further be configured to also report positional data such as geographic coordinates (e.g., latitude and longitude) to the central platform 210 either independently or with telematics data. In some embodiments, the in-vehicle monitoring devices 204 can be configured as wireless hotspots (e.g., implementing a wireless networking protocol) for the mobile devices 202. However, mobile devices 202, in-vehicle monitoring devices 204, and camera devices 206 can operate independently of one another and transmit their data to the central platform 210 independently.

The camera devices 206 can comprise dash-mounted cameras configured to record images of drivers or other occupants in vehicles. In some embodiments, the camera devices 206 can be communicatively coupled to the in-vehicle monitoring devices 204 and use the in-vehicle monitoring devices 204 as transmission devices for uploading images of drivers to the central platform 210. In some embodiments, the camera devices 206 can be equipped with a facial detection model that can identify drivers or other occupants in the vehicle. In such a scenario, the camera devices 206 can predict a driver identifier for a given camera image and report the image and associated driver identifier to the central platform 210.

The central platform 210 can comprise a server-based application platform. In some embodiments, the central platform 210 can comprise a single computing device. In other embodiments, the central platform 210 can comprise multiple computing devices operating as a private network. In some embodiments, the central platform 210 can comprise a cloud platform and thus can comprise changing amounts of hardware and instances of software. The various components of central platform 210 described herein can be implemented in software, hardware, or a combination thereof, and the disclosure is not limited to a specific deployment option.

The central platform 210 can include a core data storage layer 212. The core data storage layer 212 can provide primary storage for data received at central platform 210. In the illustrated embodiment, the core data storage layer 212 can include a mobile data store 214A. In some embodiments, the mobile data store 214A can store all data received from mobile devices 202. In some embodiments, the mobile data store 214A can store raw data and/or processed data. In some embodiments, the mobile data store 214A can comprise multiple databases and/or multiple tables for storing mobile-generated data. For example, mobile data store 214A can store mobile “pings” that comprise driver identifiers and geographic coordinates. The mobile data store 214A can also store inspection reports received via mobile applications.

The core data storage layer 212 additionally includes an ELD data store 214B. The ELD data store 214B can store raw data received from in-vehicle monitoring devices 204. In some embodiments, the ELD data store 214B can store pings received from in-vehicle monitoring devices 204. Alternatively, or in conjunction with the foregoing, the ELD data store 214B can store telematics data associated with a vehicle identifier and geographic location.

The core data storage layer 212 additionally includes a trip data store 214C. In the illustrated embodiment, the trip data store 214C can store data regarding trips performed by vehicles. In some embodiments, the trips in trip data store 214C can be generated based on the raw data from mobile devices 202 and in-vehicle monitoring devices 204. In some embodiments, for each trip, the trip data store 214C can store a trip identifier, a vehicle identifier, a start time, and end time, and an optional driver identifier. In some embodiments, if an optional driver identifier is associated with a trip, the trip is referred to as an assigned trip. If the optional driver identifier is missing, the trip is referred to as an unassigned trip.

The core data storage layer 212 additionally includes a camera data store 214D. In some embodiments, the camera data store 214D can store images (or references to images stored in a file system) received from camera devices 206. In some embodiments, a facial recognition engine 216 can predict a driver identifier (from a dataset of known drivers stored in a driver database 218) and annotate camera data stored in camera data store 214D with predicted driver identifiers. In some embodiments, the facial recognition engine 216 can store a predictive model trained using labeled images stored in driver database 218 and can output predictions in response to camera images received from camera devices 206.

The various data stores in core data storage layer 212 can comprise data stores supporting query interface and allowing various components to retrieve data from the data stores, as will be discussed next.

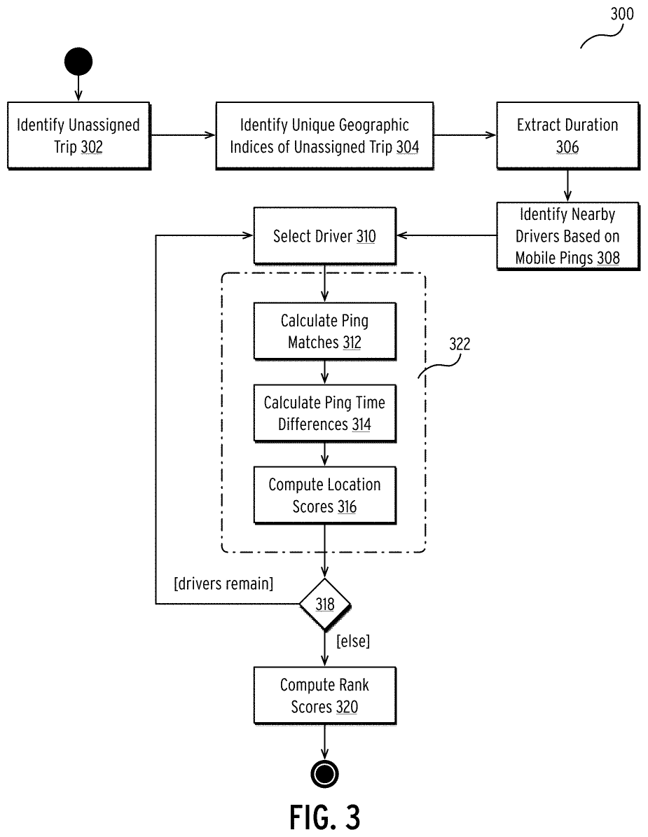

The central platform 210 includes a location scoring component 220. The location scoring component 220 is configured to load mobile data (e.g., from mobile data store 214A) and in-vehicle monitoring data (e.g., from ELD data store 214B) associated with unassigned trip (e.g., stored in trip data store 214C). The location scoring component 220 is further configured to generate a ranked list of driver identifiers based on the mobile data and in-vehicle monitoring data. FIG. 3 provides further detail on this process, and that detail is not repeated herein.

A feature generator 222 can be configured to receive the ranked list of driver identifiers from location scoring component 220. In response, the feature generator 222 can load heuristic data from core data storage layer 212 (e.g., from ELD data store 214B) and generate a set of feature vectors for a given trip. Details of this process are described in subprocess 420 and subprocess 518 for training and prediction, respectively, and are not repeated herein.

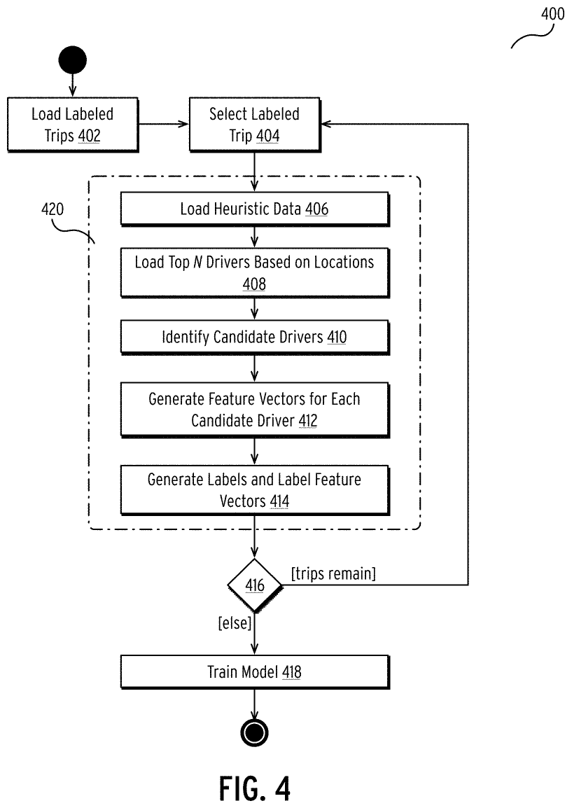

A training data generator 228 is configured to receive feature vectors from feature generator 222 and generate a training data set to train a predictive model. The training data generator 228 can label the training data set using labels 226 generated by human annotators for the trips. A model training phase 230 can use the training data set to train one or more predictive models 232 that can predict the likelihood that an unassigned trip is associated with a driver. Details of generating a training data set and training a predictive model are provided in the description of FIG. 4 and are not repeated herein.

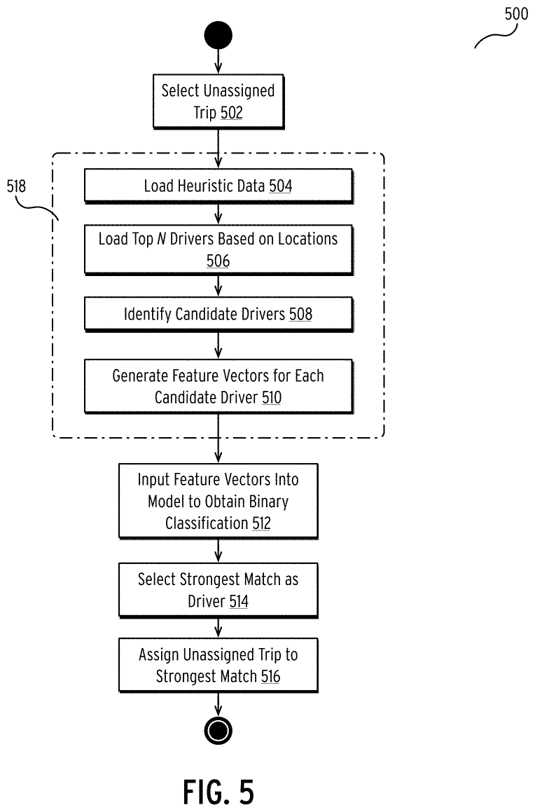

A trip predictor 224 is additionally provided to load the one or more predictive models 232. The trip predictor 224 identifies a set of candidate driver identifiers and receives corresponding feature vectors from feature generator 222. The trip predictor 224 can then input the vectors into one or more predictive models 232 and select the strongest match among the candidate drivers. The trip predictor 224 can associate an unassigned trip with the strongest matching driver. Details of the prediction operations performed by trip predictor 224 are provided in the description of FIG. 5 and are not repeated herein.

FIG. 3 is a flow diagram of a method 300 for calculating location scores for drivers associated with an unassigned trip according to some of the example embodiments.

In step 302, method 300 can include loading unassigned trip details.

In some embodiments, method 300 can be executed by a centralized platform that receives data regarding vehicle trips. For example, a fleet of vehicles such as tractor-trailers can be equipped with a monitoring device (e.g., ELD) that records data regarding the movements of the vehicles. In some embodiments, the in-vehicle monitoring devices can report data representing trips. For example, data representing a trip can include a start time and end time. In some embodiments, a trip can include an operation of the vehicle (moving and non-moving) between the start of the engine and the turning off of the engine. In some embodiments, trips can include temporary stops of the vehicle (e.g., when the engine is restarted at, for example, a rest stop or weigh station). Thus, in some embodiments, method 300 can “ignore” temporary stoppages. In some embodiments, method 300 can ignore a temporary stoppage if it is below a predetermined time, occurs at a known rest stop, weight station, or similar landmark, or satisfies any other similar condition.

Method 300 thus obtains a set of trips associated with a given vehicle and in-vehicle monitoring device. In some embodiments, these trips can be either assigned or unassigned. For example, in one embodiment, a mobile device can be paired to the monitoring device, and the mobile device can transmit a driver identifier to the monitoring device. For example, the mobile device and monitoring device can communicate via a Bluetooth® or Wi-Fi protocol. In some embodiments, the mobile device can include a mobile application that allows a driver to authenticate to the central platform. Thus, the mobile device can obtain a driver identifier from the central platform via a login process, and the mobile application can likewise provide the driver identifier to the monitoring device. In such a scenario, when the monitoring device transmits trip-related data (e.g., engine start, engine stop, periodic engine running times, position data, etc.), the monitoring device can include the driver identifier with the trip-related data. In such an embodiment, the trip associated with trip-related data augmented with a driver identifier can be automatically assigned to the driver represented by the driver identifier.

However, in some scenarios, the trip-related data may not include a driver identifier. For example, if a driver does not have the mobile application installed, does not have a mobile device, or does not connect the mobile device to the monitoring device, the monitoring device will not receive a driver identifier. As one example, a given vehicle in a fleet may be driven by multiple drivers. Thus, while the monitoring device can always record and transmit trip-related data, the monitoring device may not receive driver identification data (either accidentally or intentionally). As such, the trip-related data in such a scenario may not include a driver identifier. However, since the identification of a trip is not dependent on the identity of the driver, method 300 can still identify a trip from trip-related data that is not associated with a driver identifier.

In some embodiments, method 300 can flag trips that are not associated with a driver identifier in a database or other storage medium. For example, each trip can be stored in a record that includes an identified flag. In other embodiments, method 300 can store each trip with an optional driver identifier, and the lack of a driver identifier can be used as the flag. In either scenario or other scenarios, method 300 can identify unassigned trips by identifying those trips that are not already associated with a driver identifier. Although method 300 is described as being executed for a single vehicle and a single unassigned trip, method 300 can be executed for multiple vehicles and for multiple unassigned trips in parallel (including multiple unassigned trips for a single vehicle).

In step 304, method 300 identifies a set of unique geographic indices for the unassigned trip.

In some embodiments, the ELD messages representing the unassigned trip and the mobile pings are encoded using a set of indices. For example, a geoindexing scheme (e.g., a Geohash or H3 indexing system) can be used to assign both the ELD messages and mobile pings to a well-defined set of indices. In this manner, in step 304, method 300 can identify the unique indices for the unassigned trip. In some embodiments, step 304 can be performed in advance (e.g., when ELD messages are recorded). While indices are used in the description, in some embodiments, full coordinates (e.g., latitude/longitude/altitude) can be used.

In the embodiments, a count of the number of unique geographic indices (indicesₜᵣᵢₚ) can be used for further computations, as will be discussed. Similarly, a count of the total number of ELD messages (pingsₜᵣᵢₚ) can be computed and used for later calculations.

In step 306, method 300 extracts the duration of the identified unassigned trip (duration). In some embodiments, the duration can comprise a duration in seconds of the unassigned trip. In some embodiments, the duration can be computed by identifying a first unassigned ELD message and a last continuous unassigned ELD message (as discussed above) and computing the difference between timestamps of these messages.

In step 308, method 300 identifies a set of candidate drivers based on mobile pings. In one embodiment, the candidate drivers comprise drivers operating mobile devices with a mobile application that reports location data to the central platform. In some embodiments, this location data is encoded (e.g., using Geohash or H3) and associated with driver identifiers. As such, in step 308, method 300 can comprise querying a database of location data using the indices of the unassigned trip and a start and stop time (duration).

In step 310, method 300 can include selecting a driver from the candidate drivers and generating metrics for the driver in subprocess 322, as will be discussed. In the illustrated embodiment, method 300 can repeat subprocess 322 until determining (in step 318) that all candidate drivers have been analyzed.

In step 312, method 300 can include calculating a number of matching mobile pings (pings_{matched}) based on the recorded ELD pings. As described above, each ELD ping for an unassigned trip and each mobile ping can be assigned to a given geographic index. Further, both ping types can be associated with a timestamp. In an embodiment, method 300 matches mobile ping and ELD pings that share the same index and occur within a threshold time of one another. In an embodiment, the threshold time can be computed based on the average amount of time a driver is expected to remain within an index. For example, if the average width of an index is one mile and the speed limit of a given roadway is sixty miles per hour, a threshold time may be set as one and a half minutes (expected travel time plus a guard time). Similarly, method 300 can also calculate the number of matching indices between mobile and ELD pings (indices_{matched}). In some embodiments, the value of indices_{matched} corresponds to the number of indices shared between a given driver (represented by mobile pings) and an unassigned trip. Certainly, the higher the value of indices_{matched}, the more likely a given driver is to be responsible for the unassigned trip.

In some embodiments, from these two values (pings_{matched} and indices_{matched}), fractional representations can be computed that represent their percentage to the total number of ELD pings (pingsₜᵣᵢₚ) and the total number of unique indices (indicesₜᵣᵢₚ), respectively. That is, method 300 can comprise computing pings_{fraction}=pings_{matched}/pingsₜᵣᵢₚ and indices_{fraction}=indices_{matched}/indicesₜᵣᵢₚ.

In step 314, method 300 can include calculating time difference statistics based on mobile ping and ELD ping data. In some embodiments, the time difference statistics comprise data representing the drift (in time) between mobile pings and ELD pings within a shared index (e.g., H3 hexagon).

In some embodiments, the time difference statistics can include an aggregate (e.g., mean) minimum time difference (Δt̅ₘᵢₙ). In an embodiment, Δt̅ₘᵢₙ can be calculated by selecting all matching mobile pings and, for each matching mobile ping, selecting the nearest (in time) matching ELD ping. In this operation, the matching ELD ping comprises an ELD ping associated with the same geographic index as the mobile ping. Then, method 300 can compute a time delta between the mobile ping and the matching ELD ping. Method 300 can repeat this operation for all mobile pings and matching ELD pings. Finally, method 300 can compute the aggregate (e.g., mean) of computed time deltas to obtain Δt̅ₘᵢₙ.

In some embodiments, the time difference statistics can include an aggregate (e.g., mean) time difference (Δt̅). In an embodiment, Δt̅ can be calculated by selecting all matching mobile pings and, for each matching mobile ping, selecting all matching ELD pings (i.e., not limited to the nearest in time). In this operation, the matching ELD pings comprise ELD pings associated with the same geographic index as the mobile ping. Then, method 300 can compute a time delta between the mobile ping and the matching ELD pings, thus generating potentially multiple time deltas for a single mobile ping. Method 300 can repeat this operation for all mobile pings and matching ELD pings. Finally, method 300 can compute an aggregate (e.g., the mean) of computed time deltas to obtain Δt̅. As compared to Δt̅ₘᵢₙ, the aggregate time difference does not filter ELD pings to only consider the most temporally relevant ELD pings.

In step 316, method 300 can include generating location match scores for a given driver. In some embodiments, the location match scores can comprise aggregate measures computed using one or more of the previously described features. In an embodiment, the location match scores can include a location match score computed as LMS=indices_{matched}/Δt̅. In some embodiments, method 300 can further compute a log-based location score (LMS_{log}) as LMS_{log}=indices_{matched}/log (Δt̅).

In step 320, method 300 can include calculating an inverse location rank (rank) based on the location match scores computed for each candidate driver. In an embodiment, method 300 can sort the candidate drivers based on the computed LMS values (or LMS_{log} values) in descending order. Method 300 can compute the inverse of the rank as the value of rank. For example, a list of three users will have inverse rank scores of ½, ½, and ⅓, for the first, second, and third-ranked users (respectively).

As illustrated, the values of duration, indicesₜᵣᵢₚ, pingsₜᵣᵢₚ, pings_{matched}, pings_{fraction}, indices_{matched}, indices_{fraction}, Δt̅ₘᵢₙ, Δt̅, LMS, LMS_{log}, and rank can be computed for each candidate driver of a given unassigned trip. In some embodiments, the values of duration, indicesₜᵣᵢₚ, pingsₜᵣᵢₚ, pings_{matched}, pings_{fraction}, indices_{matched}, indices_{fraction}, Δt̅ₘᵢₙ, Δt̅, LMS, LMS_{log}, and rank can be combined and represented as a location match vector L for downstream computations.

In some embodiments, the location match vector L can include each of duration, indicesₜᵣᵢₚ, pingsₜᵣᵢₚ, pings_{matched}, pings_{fraction}, indices_{matched}, indices_{fraction}, Δt̅ₘᵢₙ, Δt̅, LMS, LMS_{log}, and rank. In other embodiments, a subset of the values of duration, indicesₜᵣᵢₚ, pingsₜᵣᵢₚ, pings_{matched}, pings_{fraction}, indices_{matched}, indices_{fraction}, Δt̅ₘᵢₙ, Δt̅, LMS, LMS_{log}, and rank can be used to construct L.

FIG. 4 is a flow diagram of a method 400 for training a driver model according to some of the example embodiments.

In step 402, method 400 can include loading a set of labeled trips.

In one embodiment, labeled trips refer to trip data (described above) associated with a driver identifier (the label, id_{known}). In some embodiments, the label is manually added by a human annotator based on their analysis of the trip data. In such an embodiment, the trip data may initially be an unassigned trip and may be labeled by a human annotator. In other embodiments, the trip data may comprise an automatically assigned trip, and the label can be extracted from the trip data (e.g., extracting the automatically assigned driver identifier). In another embodiment, the label can be generated based on facial recognition data. That is, dashcam images can be classified using a pre-trained facial recognition classifier to predict a driver identifier based on the dashcam images. These dashcam images (and predicted driver identifiers) can be associated with a specific vehicle via a vehicle identifier associated with the dashcam images. Then, the dashcam images (and predicted driver identifier) can be associated with the trip data based on timestamps of the dashcam images and a start and end time of the trip represented by the trip data.

In step 404, method 400 can include selecting a trip from the set of labeled trips. Method 400 can then generate a feature vector for each trip in subprocess 420, as will be discussed. In the illustrated embodiment, method 400 can repeat subprocess 420 until determining (in step 416) that all trips have been analyzed. In the illustrated embodiment, subprocess 420 takes, as input, a labeled trip and generates, as output, a set of labeled feature vectors (i.e., labeled examples). Notably, this set of labeled examples can include both positive and negative examples to improve the model training process in step 418, as will be discussed.

In step 406, method 400 loads heuristic data for a selected trip. In an embodiment, the heuristic data can include a most recent inspection report (id_{inspection}) a previous driver identifier (idₚᵣₑᵥ), a next driver identifier (idₙₑₓₜ), and (optionally) a facial recognition result (id_{facial}).

In some embodiments, the central platform can receive pre-trip inspection reports from drivers or other persons associated with a vehicle. The pre-trip inspection report can be associated with a user identifier. In some scenarios, the user identifier can comprise a driver identifier. However, in some scenarios, the user identifier can comprise an identifier of a user other than the user actually driving during the unassigned trip. As such, method 400 does not place a limit on the identifier received in the inspection report but rather uses the identifier as a factor in determining a driver during the unassigned trip. The inspection report may include other data such as a time, carrier name or identifier, geographic location, odometer reading, inspection type enumeration, vehicle defects (including component name, type, notes, and photos), trailer defects (including component name, type, notes, and photos), status (e.g., whether defects need correction), as well as signatures of a driver and mechanic. Some or all of this data can be used to determine a driver during an unassigned trip, as will be discussed.

In some embodiments, method 400 can identify the most recent inspection report by loading all inspection reports a preset distance from the start time of the trip selected in step 404. For example, if the trip selected in step 404 has a start time of t₁, method 400 can select all inspection reports for the vehicle received between t₀ and t₁, where t₀<t₁ and Δt=t₁−t₀, where Δt represents a preconfigured time window. For example, Δt can comprise a fifteen-minute window. In some embodiments, no such windows can be used and the most recent inspection report appearing at some time t before t₁ can be selected, regardless of its date or time.

Method 400 can further access a database of trips that includes the trip selected in step 404. In some embodiments, method 400 can be executed in a batch mode (e.g., at the end of a business day), and thus, the trip selected in step 404 may be temporally situated between other assigned trips. As previously discussed, an assigned trip can be automatically associated with a driver identifier. As such, if the trip selected in step 404 occurs between assigned trips, the assigned trips will be associated with respective driver identifiers. That is, an assigned trip occurring before the trip selected in step 404 can be associated with a previous driver identifier. Similarly, an assigned trip occurring after the trip selected in step 404 can be associated with a next driver identifier. Certainly, in some embodiments, one or both of these driver identifiers may be absent. For example, if no trips occur before or after the unassigned trip, a previous and next driver identifier, respectively, will not be present. Similarly, if either a previous or next trip is unassigned, the trip will not be associated with a driver identifier. Thus, as with inspection reports, method 400 does not require previous and next driver identifiers but will operate with or without such identifiers (e.g., null values).

In some embodiments, method 400 can also include identifying one or more frequent driver identifiers for the vehicle. As described above, a given vehicle can be associated with multiple assigned trips. Since these assigned trips are each associated with a driver identifier, method 400 can identify a driver identifier that occurs most frequently for a set of assigned trips for a given vehicle.

In some embodiments, the vehicle associated with the trip selected in step 404 can be equipped with a camera. In some embodiments, this camera can comprise an inward-facing camera or a dual-facing camera. In either embodiment, the camera can be configured to record images of a driver and transmit those images to a central platform at regular intervals. In some embodiments, the central platform can include a facial detection model that can identify a driver based on images of drivers. In some embodiments, the facial detection model can comprise a machine learning model such as a convolutional neural network (CNN) or similar network. In these embodiments, the central platform can train the model using label images of known drivers. In some embodiments, the labels can comprise driver identifiers. As such, during prediction, the central platform can receive the images captured by a vehicle and predict a driver identifier for the image. In some embodiments, the output of the model can also include a confidence level of the predicted driver identifier.

If facial identification is used, each predicted driver identifier can be associated with a timestamp. As such, method 400 can load all predicted driver identifiers timestamped between the start time of the trip selected in step 404 and the stop time of the trip selected in step 404. Method 400 can then select a driver identifier from the matching driving identifiers. In some embodiments, the driver identifiers recorded between the start time of the trip selected in step 404 and stop time of the trip selected in step 404 can comprise the same driver identifier, while in other embodiments, multiple driver identifiers can be predicted between the start time of the trip selected in step 404 and stop time of the trip selected in step 404. As such, in some embodiments, method 400 can include selecting the most frequently occurring driver identifier predicted between the start time of the trip selected in step 404 and the stop time of the trip selected in step 404.

In step 408, method 400 can load a set of top N drivers based on the location scoring method described in FIG. 3, which is not repeated herein. In brief, the location scoring method of FIG. 3 outputs a set of N drivers (id₁, id₂, . . . id_{N}) (ranked by location match scores) and corresponding location match vectors (L₁, L₂, . . . L_{N}).

In step 410, method 400 can include identifying one or more candidate drivers. In one embodiment, method 400 can select all unique driver identifiers from the set S={idₚᵣₑᵥ, idₙₑₓₜ, id_{inspection}, id_{facial}, id₁, id₂, . . . id_{N}}. Certainly, some identifiers may be repetitive and thus the number of candidate drivers may be less than the size of S.

In step 412, method 400 can include generating a feature vector Fᵢ for each candidate driver i in the set S. As used herein, idᵢ refers to a selected driver identifier in the set S, and step 412 can be repeated for each driver identifier in the set S.

In an embodiment, method 400 can comprise computing binary comparisons using the heuristic data and N drivers loaded in step 406. As described, the driver identifiers in the heuristic may comprise alphanumeric identifiers (e.g., string data). In one embodiment, as illustrated, method 400 can further comprise using the raw driver identifiers to compute binary comparisons with an expected value. In one embodiment, each value can be combined (via a comparison operation) with the expected driver identifier (i.e., the label) to generate a set of binary features.

For example, the previous driver identifier (idₚᵣₑᵥ) can be compared with the selected candidate driver identifier (idᵢ) to generate the binary feature feat_{prev,i}=(idₚᵣₑᵥ==idᵢ). Similarly, the next driver identifier (idₙₑₓₜ) can be compared with the selected candidate driver identifier (idᵢ) to generate the binary feature feat_{next,i}=(idₙₑₓₜ==idᵢ). Similarly, the inspection driver identifier (id_{inspection}) can be compared with the selected candidate driver identifier (idᵢ) to generate the binary feature feat_{inspection,i}=(id_{inspection}==idᵢ). Similarly, the facial driver identifier (id_{facial}) can be compared with the selected candidate driver identifier (idᵢ) to generate the binary feature feat_{facial,i}=(id_{facial}==idᵢ). Finally, method 400 can identify whether a matching driver exists in the set {id₁, id₂, . . . id_{N}} and compare a match to id₁ (i.e., feat_{mobile,i}=idᵢ ∈ {id₁, id₂, . . . id_{N}}). Since the set S includes all drivers id₁, id₂, id_{N}, the value of feat_{mobile} will be true for all such drivers and false for any other drivers (e.g., those identified by idₙₑₓₜ, idₚᵣₑᵥ, id_{inspection}, or id_{facial}.

In this manner, the raw driver identifiers global to all candidate drivers are converted into driver-specific binary comparisons which reflect the match between the candidate driver identifier and various heuristic driver identifiers. Table 1 provides a further example with three hypothetical candidate drivers:

TABLE 1

| idᵢ | idₚᵣₑᵥ | featₚᵣₑᵥ | idₙₑₓₜ | featₙₑₓₜ | id_{inspection} | feat_{inspection} | id_{mobile} | feat_{mobile} |
|---|---|---|---|---|---|---|---|---|
| 10 | 10 | 1 | 10 | 1 | NULL | 0 | NULL | 0 |
| 11 | 10 | 0 | 10 | 0 | NULL | 0 | 11 | 1 |
| 12 | 10 | 0 | 10 | 0 | NULL | 0 | 12 | 1 |

As illustrated, some heuristic data (e.g., id_{inspection}) can be NULL (i.e., not found or recorded). In such scenarios, the resulting binary comparison will always be zero. Additionally, the foregoing table does not include a facial identifier (id_{facial}) which may be optional. If optional, the value of id_{facial} may alternatively be set to NULL.

The foregoing binary comparison features (feat_{prev,i}, feat_{next,i}, feat_{inspection,i}, feat_{mobile,i}, and optional feat_{facial,i}) can be combined into a vector Bᵢ for ease of description. In some embodiments, the vector Bᵢ can also include the identifier of the candidate driver. Although, in some embodiments, the candidate driver identifier may be omitted.

After generating the binary comparison vector Bᵢ for each candidate driver, method 400 can include augmenting the binary comparison vector Bᵢ with the location match vector Lᵢ for each candidate driver idᵢ. In some embodiments, if a given candidate driver is not identified using the location scoring method of FIG. 3, method 400 can assign a default location match vector Lᵢ which includes minimum or maximum values for the various features or the vector (e.g., zero for countable values or a maximum time value for aggregate time values). The combination of Bᵢ and Lᵢ is equal to Fᵢ.

In step 414, method 400 can include generating a label (labelᵢ) for each candidate driver and labeling each feature vector Fᵢ. In an embodiment, the value of labelᵢ can comprise a binary comparison between the candidate driver identifier (idᵢ) and the known driver identifier (id_{known}). As such, the label can comprise a binary classification label that is generated for each candidate driver. Further, the set of feature vectors can include both positive and negative examples used for training.

As illustrated, method 400 can repeat step 404 through step 414 for each trip used for training a model. The set of feature vectors generated during this process represents a labeled training set for training a predictive model.

In step 418, method 400 can include training the predictive model using the labeled training set. In some embodiments, various binary classification models can be used, such as decision tree, random forest, eXtreme Gradient Boosting (XGBoost) models. Other types of models may be used, such as neural networks or deep learning models. In some embodiments, the training set can be segmented into a training set, and a validation set according to a predefined split position. In some embodiments, the trained model can be represented by a set of parameters or another serializable data format for reuse during a prediction phase (discussed next).

FIG. 5 is a flow diagram of a method 500 for assigning a driver to unassigned driving time according to some of the example embodiments.

In step 502, method 500 can comprise loading an unassigned trip. Details on the distinctions between unassigned and assigned trips have been described previously and are not repeated herein. In step 502, method 500 can load data describing an unassigned trip, such as a vehicle identifier, start time, and end time. Method 500 can, in some embodiments, also compute (or load) the duration of the unassigned trip. After selecting an unassigned trip, method 500 executes a subprocess 518 to generate a set of feature vectors for the unassigned trip.

In step 504, method 500 loads heuristic data for the unassigned trip. In an embodiment, the heuristic data can include a most recent inspection report (id_{inspection}), a previous driver identifier (idₚᵣₑᵥ), a next driver identifier (idₙₑₓₜ), and (optionally) a facial recognition result (id_{facial}). Details of id_{inspection}, idₚᵣₑᵥ, idₙₑₓₜ, and id_{facial} were described in connection with step 406 and are not repeated herein. In the illustrated embodiment, method 400 can load the heuristic data by querying a database using the vehicle identifier associated with the unassigned trip.

In step 506, method 500 can load a set of top N drivers based on the location scoring method described in FIG. 3, which is not repeated herein. In brief, the location scoring method of FIG. 3 outputs a set of N drivers (id₁, id₂, id_{N}) (ranked by location match scores) and corresponding location match vectors (L₁, L₂, . . . L_{N}).

In step 508, method 500 can include identifying one or more candidate drivers. In one embodiment, method 500 can select all unique driver identifiers from the set S={idₚᵣₑᵥ, idₙₑₓₜ, id_{inspection}, id_{facial}, id₁, id₂, . . . id_{N}}. Certainly, some identifiers may be repetitive, and thus the number of candidate drivers may be less than the size of S.

In step 510, method 500 can include generating a feature vector Fᵢ for each candidate driver i in the set S. As used herein, idᵢ refers to a selected driver identifier in the set S, and step 412 can be repeated for each driver identifier in the set S.

In an embodiment, method 500 can comprise computing binary comparisons using the heuristic data and N drivers loaded in step 406. As described, the driver identifiers in the heuristic may comprise alphanumeric identifiers (e.g., string data). In one embodiment, as illustrated, method 500 can further comprise using the raw driver identifiers to compute binary comparisons with an expected value. In one embodiment, each value can be combined (via a comparison operation) with the expected driver identifier (i.e., the label) to generate a set of binary features.

For example, the previous driver identifier (idₚᵣₑᵥ) can be compared with the selected candidate driver identifier (idᵢ) to generate the binary feature feat_{prev,i}=(idₚᵣₑᵥ==idᵢ) Similarly, the next driver identifier (idₙₑₓₜ) can be compared with the selected candidate driver identifier (idᵢ) to generate the binary feature feat_{next,i}=(idₙₑₓₜ==idᵢ). Similarly, the inspection driver identifier (id_{inspection}) can be compared with the selected candidate driver identifier (idᵢ) to generate the binary feature feat_{inspection,i}=(id_{inspection}==idᵢ). Similarly, the facial driver identifier (id_{facial}) can be compared with the selected candidate driver identifier (idᵢ) to generate the binary feature feat_{facial,i}=(id_{facial}==idᵢ). Finally, method 400 can identify whether a matching driver exists in the set {id₁, id₂, id_{N}} and compare a match to id₁ (i.e., feat_{mobile,i}=id₁ E {id₁, id₂, . . . id_{N}}. Since the set S includes all drivers id₁, id₂, . . . id_{N}, the value of feat_{mobile} will be true for all such drivers and false for any other drivers (e.g., those identified by idₙₑₓₜ, idₚᵣₑᵥ, id_{inspection}, or id_{facial}.

In this manner, the raw driver identifiers global to all candidate drivers are converted into driver-specific binary comparisons, which reflect the match between the candidate driver identifier and various heuristic driver identifiers. Table 1 provided a further example with three hypothetical candidate drivers and is not repeated herein.

The foregoing binary comparison features (feat_{prev,i}, feat_{next,i}, feat_{inspection,i}, f_{mobile,i}, and optional feat_{facial,i}) can be combined into a vector Bᵢ for ease of description. In some embodiments, the vector Bᵢ can also include the identifier of the candidate driver. Although, in some embodiments, the candidate driver identifier may be omitted and used solely for classification after receiving a classification result. After generating the binary comparison vector Bᵢ for each candidate driver, method 500 can include augmenting the binary comparison vector Bᵢ with the location match vector Lᵢ for each candidate driver idᵢ. In some embodiments, if a given candidate driver is not identified using the location scoring method of FIG. 3, method 500 can assign a default location match vector Lᵢ which includes minimum or maximum values for the various features or the vector (e.g., zero for countable values or a maximum time value for aggregate time values). The combination of Bᵢ and Lᵢ is equal to Fᵢ.

In step 512, method 500 can include inputting the feature vectors into a model to obtain a binary classification. As discussed in connection with FIG. 4, the model can comprise a binary classification model that classifies a given feature vector as being associated with a driver associated with the unassigned trip. As such, the output (i.e., label) output by the model comprises a true or false label (or yes or no label, etc.). In some embodiments, method 500 retains the candidate driver identifier used to compute the binary classification vector Bᵢ and can use this retained identifier to classify the candidate driver identifiers based on the model output.

In step 514, method 500 can include selecting a strongest match as a driver for the unassigned trip. As used herein, a “strongest” match refers to a driver that probabilistically is the most likely driver of the vehicle associated with the unassigned trip. In some embodiments, method 500 can parse the model outputs and identify which output indicates a positive label (e.g., true, or yes). Method 500 can then use this match as the strongest match. In some embodiments, the model can further output a confidence level of the prediction. In such a scenario, the confidence level can be used to rank the predictions and the highest confidence match can be used as the strongest match.

In step 516 method 500 can include assigning the unassigned trip to the strongest matched driver identifier. In some embodiments, method 500 can update a database of trips to store the driver identifier of the strongest match with the unassigned trip, thus converting the unassigned trip to an assigned trip. Alternatively, method 500 can temporarily associate the driver identifier of the strongest match with the unassigned trip and provide a user interface to allow a fleet manager or other entity to review the prediction and finalize the assignment.

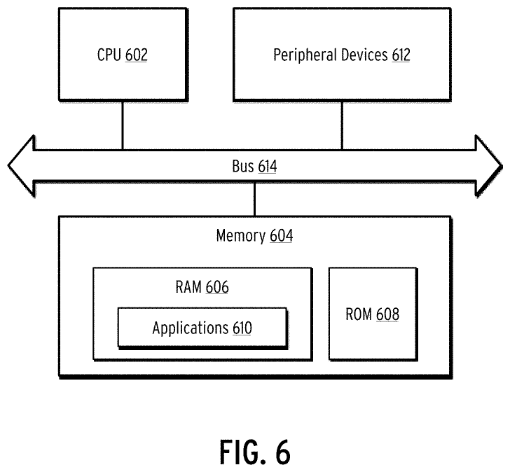

FIG. 6 is a block diagram of a computing device according to some embodiments of the disclosure. In some embodiments, the computing device can be used to train and use the various machine learning models described previously.

As illustrated, the device includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad or software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
loading heuristic data associated with a trip performed by a vehicle, the heuristic data comprising at least one driver identifier;
identifying a plurality of driver identifiers near to the vehicle during the trip, the plurality of driver identifiers based on mobile device data and in-vehicle monitoring data;
generating a set of binary comparisons based on the heuristic data; and
generating a set of vectors based on the plurality of driver identifiers and the set of binary comparisons.

2. The method of claim 1, further comprising:
classifying the set of vectors to obtain a set of predictions;
selecting a prediction from the set of predictions; and
assigning a driver identifier associated with the prediction to the trip.

3. The method of claim 2, wherein classifying the set of vectors comprises classifying the set of vectors using a predictive model, the predictive model generating a binary classification for each vector in the set of vectors.

4. The method of claim 1, further comprising:
assigning a label to each vector in the set of vectors to generate a set of labeled vectors; and
training a predictive model using the set of labeled vectors, the predictive model generating a binary classification for each vector in the set of vectors.

5. The method of claim 1, wherein the heuristic data comprises driver identifiers associated with one or more of a previous trip, a next trip, and an inspection report.

6. The method of claim 5, wherein generating a set of binary comparisons comprises comparing a candidate driver identifier to the driver identifiers in the heuristic data and to a matching driver identifier in the plurality of driver identifiers.

7. The method of claim 1, wherein identifying a plurality of driver identifiers near to the vehicle during the trip comprises analyzing position and time data associated with a plurality of mobile device pings and a plurality of in-vehicle monitoring device pings and generating a feature vector based on the analysis.

8. A non-transitory computer-readable storage medium for tangibly storing computer program instructions capable of being executed by a computer processor, the computer program instructions defining steps of:
loading heuristic data associated with a trip performed by a vehicle, the heuristic data comprising at least one driver identifier;
identifying a plurality of driver identifiers near to the vehicle during the trip, the plurality of driver identifiers based on mobile device data and in-vehicle monitoring data;
generating a set of binary comparisons based on the heuristic data; and
generating a set of vectors based on the plurality of driver identifiers and the set of binary comparisons.

9. The non-transitory computer-readable storage medium of claim 8, the steps further comprising:
classifying the set of vectors to obtain a set of predictions;
selecting a prediction from the set of predictions; and
assigning a driver identifier associated with the prediction to the trip.

10. The non-transitory computer-readable storage medium of claim 9, wherein classifying the set of vectors comprises classifying the set of vectors using a predictive model, the predictive model generating a binary classification for each vector in the set of vectors.

11. The non-transitory computer-readable storage medium of claim 8, the steps further comprising:
assigning a label to each vector in the set of vectors to generate a set of labeled vectors; and
training a predictive model using the set of labeled vectors, the predictive model generating a binary classification for each vector in the set of vectors.

12. The non-transitory computer-readable storage medium of claim 8, wherein the heuristic data comprises driver identifiers associated with one or more of a previous trip, a next trip, and an inspection report.

13. The non-transitory computer-readable storage medium of claim 12, wherein generating a set of binary comparisons comprises comparing a candidate driver identifier to the driver identifiers in the heuristic data and to a matching driver identifier in the plurality of driver identifiers.

14. The non-transitory computer-readable storage medium of claim 8, wherein identifying a plurality of driver identifiers near to the vehicle during the trip comprises analyzing position and time data associated with a plurality of mobile device pings and a plurality of in-vehicle monitoring device pings and generating a feature vector based on the analysis.

15. A device comprising:
a processor configured to:
load heuristic data associated with a trip performed by a vehicle, the heuristic data comprising at least one driver identifier;
identify a plurality of driver identifiers near to the vehicle during the trip, the plurality of driver identifiers based on mobile device data and in-vehicle monitoring data;
generate a set of binary comparisons based on the heuristic data; and
generate a set of vectors based on the plurality of driver identifiers and the set of binary comparisons.

16. The device of claim 15, the processor further configured to:
classify the set of vectors to obtain a set of predictions;
select a prediction from the set of predictions; and
assign a driver identifier associated with the prediction to the trip.

17. The device of claim 15, the processor further configured to:
assign a label to each vector in the set of vectors to generate a set of labeled vectors; and
train a predictive model using the set of labeled vectors, the predictive model generating a binary classification for each vector in the set of vectors.

18. The device of claim 15, wherein the heuristic data comprises driver identifiers associated with one or more of a previous trip, a next trip, and an inspection report.

19. The device of claim 18, wherein generating a set of binary comparisons comprises comparing a candidate driver identifier to the driver identifiers in the heuristic data and to a matching driver identifier in the plurality of driver identifiers.

20. The device of claim 15, wherein identifying a plurality of driver identifiers near to the vehicle during the trip comprises analyzing position and time data associated with a plurality of mobile device pings and a plurality of in-vehicle monitoring device pings and generating a feature vector based on the analysis.
